(19) United States
(12) Patent Application Publication
(10) Pub. No.: US 2024/0351895 A1
(43) Pub. Date: Oct. 24, 2024

(54) METHOD FOR PREPARING A ZEOLITE MATERIAL WITH A HIGH KL ZEOLITE CONTENT AND A HIGH MECHANICAL STRENGTH

(71) Applicant: IFP ENERGIES NOUVELLES, RUEIL-MALMAISON (FR)

(72) Inventors: Souad RAFIK-CLEMENT, RUEIL-MALMAISON CEDEX (FR); Bogdan HARBUZARU, RUEIL-MALMAISON CEDEX (FR)

(73) Assignee: IFP ENERGIES NOUVELLES, RUEIL-MALMAISON (FR)

(21) Appl. No.: 18/291,749

(22) PCT Filed: Jul. 7, 2022
(86) PCT No.: PCT/EP2022/068999

§ 371 Date: Jan. 24, 2024

(30) Foreign Application Priority Data
Jul. 29, 2021 (FR) FR2108266

(51) Int. Cl. C01B 39/32

(52) U.S. Cl. CPC C01B 39/32; C01P 2002/72; C01P 2006/21

(57) ABSTRACT

The present invention relates to a method for the preparation of a microporous material shaped in the form of extrudates, tablets or beads having good mechanical crush strength and containing at least 90% by weight of KL zeolite (structural type LTL). This method comprises a stage of shaping a KL zeolite with at least one zeolitizable binder and at least one stage of zeolitization, in the presence of potassium hydroxide in one and/or the other of the stages, in order to obtain a material shaped in the form of extrudates, tablets or beads containing at least 90% by weight of KL zeolite and good mechanical crush strength.

### TECHNICAL FIELD

The present invention relates to a method for the preparation of a microporous material shaped in the form of extrudates, tablets or beads having good mechanical crush strength and containing at least 90% by weight of KL zeolite (structural type LTL). This method comprises a stage of shaping this zeolite in the powder form with at least one zeolitizable binder and at least one stage of zeolitization, in order to obtain a shaped material, containing at least 90% by weight of KL zeolite and good mechanical crush strength.

### PRIOR ART

Zeolites are crystalline aluminosilicate materials having an organized microporosity formed by the three-dimensional arrangement of SiO₄⁴⁻ and AlO₄⁵⁻ tetrahedra, thus providing a greater diversity of structures. The International Zeolite Association (IZA) has produced a classification of zeolites according to their structures (structural types). Zeolites are widely used in industry for adsorption, separation, catalysis or also ion exchange. To be used in industrial processes, zeolites are shaped in order to obtain objects of larger size than zeolite crystals and thus to facilitate their handling but also to facilitate the passage of the feedstock in the reactors. KL zeolite is a zeolite of LTL structural type containing a one-dimensional microporous system with pore openings having 12 T atoms (T being silicon or aluminum). The cation for compensation of the charge of the structure is K⁺.

The patent U.S. Pat. No. 4,830,732 presents a method for obtaining a shaped material containing a KL zeolite. The method consists in mixing a KL zeolite with a silica or a pseudoboehmite and in then shaping the mixture by kneading-extrusion. Aluminum nitrate is added to increase the mechanical strength of the extrudates. The percentage of KL zeolite with respect to the total weight of KL zeolite and silica or pseudoboehmite is 80%. The patent does not present any data in the examples on the mechanical strength of the extrudates which are obtained.

The patent U.S. Pat. No. 5,354,933 presents a method for obtaining a shaped material containing a KL zeolite. The method consists in mixing a KL zeolite with a silica and in then shaping the mixture by kneading-extrusion. The percentage of KL zeolite with respect to the total weight of KL zeolite and silica is 83%. The patent does not present any data on the mechanical strength of the extrudates which are obtained.

The patent U.S. Pat. No. 5,980,731 presents a material shaped in the form of extrudates containing an MgKL zeolite and alumina. The percentage of MgKL zeolite with respect to the total weight of MgKL zeolite and alumina is 70%. The patent does not present any data on the mechanical strength of the extrudates which are obtained.

The patent U.S. Pat. No. 6,207,042 presents a method for obtaining a shaped material containing a KL zeolite. The method consists in mixing a KL zeolite with a silica and methocel and in then shaping the mixture by kneading-extrusion. The percentage of KL zeolite with respect to the total weight of KL zeolite and silica is 83%. The patent does not present any data on the mechanical strength of the extrudates which are obtained.

The patent U.S. Pat. No. 6,358,400 presents a material formed in the form of extrudates containing an SnKL zeolite and silica. The percentage of SnKL zeolite with respect to the total weight of SnKL zeolite and silica is 85%. The patent does not present any data on the mechanical strength of the extrudates which are obtained.

The patent U.S. Pat. No. 8,263,518 presents a material formed in the form of extrudates containing a KL zeolite and silica. The percentage of KL zeolite with respect to the total weight of KL zeolite and silica is 83%. The patent does not present any data on the microporous volume of the extrudates which are obtained. The mechanical strength of the extrudates which are obtained is greater than 3 lbf/mm (1.3 daN/mm).

The processes of the prior art show that it is very difficult to shape a mixture containing a very high content of KL zeolite and to obtain a shaped object having good mechanical strength.

Surprisingly, the applicant company has discovered that the shaping of a zeolitic material in the form of extrudates, tablets or beads starting from the KL zeolite mixed with at least one zeolitizable binder, followed by a zeolitization stage, in the presence of potassium hydroxide in one and/or the other of the stages of the process, results in a material containing at least 90% by weight of KL zeolite, while having good mechanical strength.

### SUMMARY OF THE INVENTION

The invention relates to a process for the preparation of a microporous zeolitic material shaped in the form of extrudates, tablets or beads having a mechanical crush strength of greater than or equal to 0.7 daN/mm and containing at least 90% by weight of KL zeolite of LTL structural type, comprising:
i) a stage of shaping a KL zeolite powder, as a mixture with at least one zeolitizable binder, optionally in the presence of potassium hydroxide, in order to obtain extrudates, tablets or beads of partially zeolitic material;
ii) at least one stage of zeolitization of said shaped partially zeolitic material of stage i) by bringing into contact with water or with an aqueous potassium hydroxide solution in vapor or liquid form at a temperature of between 95° C. and 200° C. for a period of time of between 5 and 72 hours, washing and then drying in order to obtain a microporous zeolitic material in the form of extrudates, tablets or beads containing at least 90% by weight of KL zeolite and having a mechanical crush strength of greater than or equal to 0.7 daN/mm,
the potassium hydroxide being introduced in stage i) and/or in stage ii).

Said at least one zeolitizable binder can be chosen from kaolin, metakaolin or any other zeolitizable clay, or mixtures of silica and alumina, such as colloidal silica, pyrogenic silicas, sodium silicate, sodium aluminate, boehmites or aluminum hydroxide, alone or as a mixture.

The shaping can be carried out by extrusion, pelletizing, agglomeration or spheronization. Stage i) can comprise gentle drying of the shaped extrudates, beads or tablets at a temperature of between 60° C. and 95° C., preferably between 75° C. and 90° C., for a period of time of between 1 and 24 hours.

Said drying can be followed by a calcination of the dried extrudates, beads or tablets at a temperature of between 300° C. and 550° C. for a period of time of between 2 and 8 hours.

In one embodiment, the dried and optionally calcined extrudates, beads or tablets can be impregnated with a potassium hydroxide solution before the zeolitization stage ii).

Said zeolitization stage ii) can be carried out by heat treatment in the presence of water or of a potassium hydroxide solution under autogenous pressure in a closed reactor.

In a first alternative form, said shaped partially zeolitic material can be brought into contact with water by immersion in water or the aqueous potassium hydroxide solution in liquid form.

In a second alternative form, said shaped partially zeolitic material can be brought into contact with water or the aqueous potassium hydroxide solution in vapor form.

The zeolitic material obtained after the zeolitization of stage ii) can be washed several times with water in order to obtain a final pH in the aqueous washing liquors of between 7 and 8, and then dried at a temperature of between 80° C. and 130° C., preferably between 90° C. and 120° C., for 1 to 24 hours, preferably between 2 and 12 hours.

The preparation process according to the invention can comprise a stage iii) of calcination of the extrudates, beads or tablets of microporous zeolitic material which is obtained in stage ii) at a temperature of between 300° C. and 550° C. for a period of time of between 2 and 8 hours, after the zeolitization stage(s) ii).

The zeolitizable binder can comprise a source of alumina, which is aluminum hydroxide, and a source of silica, which is a colloidal silica.

The zeolitizable binder can comprise kaolin or metakaolin.

The amount of potassium hydroxide optionally introduced in stage i) is advantageously chosen in order to obtain a molar ratio of the silica of the zeolitizable binder, considered in its SiO₂ form, to the potassium, considered in its K₂O form, of between 3 and 5, limits included, and the amount of potassium hydroxide optionally introduced in the zeolitization stage ii) is advantageously chosen in order to obtain a molar ratio of the source of silica of the zeolitizable binder, considered in its oxide SiO₂ form, to the potassium hydroxide, considered in its oxide K₂O form, of between 0.5 and 5, limits included.

The potassium hydroxide can be introduced in both stages i) and ii) and the total amount of potassium hydroxide introduced in stages i) and ii) is chosen in order to obtain a molar ratio of the source of silica of the zeolitizable binder, considered in its oxide SiO₂ form, to the potassium hydroxide, considered in its oxide K₂O form, of between 3 and 5, limits included.

The invention also relates to the use of the microporous zeolitic material obtained according to any one of the alternative forms of the process according to the invention as catalyst support, adsorbent or separating agent.

### LIST OF THE FIGURES

Other characteristics and advantages of the process according to the invention will become apparent on reading the description below of nonlimiting implementational examples, with reference to the appended figures described below.

FIG. 1 represents the X-ray diffraction diagram (XRD) of the pure KL zeolite (reference sample) obtained according to example 1.

FIG. 2 represents the X-ray diffraction diagram (XRD) of the microporous zeolitic material obtained according to example 2.

FIG. 3 represents the X-ray diffraction diagram (XRD) of the microporous zeolitic material obtained according to example 3.

FIG. 4 represents the X-ray diffraction diagram (XRD) of the microporous zeolitic material obtained according to example 4.

FIG. 5 represents the X-ray diffraction diagram (XRD) of the microporous zeolitic material obtained according to example 5.

FIG. 6 represents the X-ray diffraction diagram (XRD) of the microporous zeolitic material obtained according to example 6.

### DESCRIPTION OF THE EMBODIMENTS

According to the invention, the Si/Al molar ratio defines the molar ratio of the molar amount of silicon element, denoted Si, to the molar amount of aluminum element, denoted Al, of the microporous aluminosilicate KL zeolite of LTL structural type. The Si/Al ratios are calculated from the molar amounts of the element silicon Si and of the element aluminum Al present in the microporous zeolitic material considered, said molar amounts being determined by the X-ray fluorescence spectrometry method.

According to the present invention, the expression “of between . . . and . . . ” means that the limiting values of the interval are included in the range of values which is described. Should such not be the case and should the limiting values not be included in the range described, such a clarification will be provided by the present invention.

According to the present invention, the expression “under autogenous pressure” means the pressure generated in a closed reactor subjected to temperatures of greater than 25° C. by the simple evaporation of the water present in this reactor.

According to the present invention, the expression “zeolitizable binder” means any source of silica and alumina which is easily converted into KL zeolite in the presence of potassium hydroxide.

According to the present invention, the expression “zeolitization” means the process during which the source of silica and alumina is converted into KL zeolite in the presence of potassium hydroxide.

According to the present invention, the “loss on ignition” (LOI) is the percentage of loss of weight of a solid after its calcination at 1000° C. for 1 hour.

Furthermore, subsequently, particular and/or preferred embodiments of the invention may be described. They can be employed separately or combined together, without limitation of combination when this is technically feasible.

The present invention relates to a process for the preparation of a microporous zeolitic material shaped in the form of extrudates, tablets or beads having good mechanical crush strength and having a high content of KL zeolite, that is to say containing at least 90% by weight of KL zeolite (LTL structural type). The process comprises at least:
a stage of shaping a mixture of a KL zeolite with at least one zeolitizable binder in order to obtain extrudates, tablets or beads;
and at least one zeolitization stage, in order to obtain a material containing at least 90% by weight of KL zeolite having good mechanical crush strength, one and/or the other of the stages being carried out in the presence of potassium hydroxide.

If necessary, the zeolitization stage can be repeated one or more times in order to reach the required percentage of KL zeolite.

The shaping can be carried out by any method known to a person skilled in the art, such as, for example, by extrusion, in particular kneading-extrusion if necessary, pelletizing, agglomeration or spheronization.

A material such as obtained by the process according to the present invention containing more than 90% by weight of KL zeolite and having a high mechanical strength, in particular of greater than or equal to 0.7 daN/mm, can then advantageously be employed as adsorbent, catalyst support or separating agent.

More particularly, the invention relates to a process for the preparation of a microporous zeolitic material shaped in the form of extrudates, tablets or beads having a mechanical crush strength of greater than or equal to 0.7 daN/mm and containing at least 90% by weight of KL zeolite of LTL structural type, starting from KL zeolite and in the presence of potassium hydroxide in one and/or the other of the stages, comprising:
i) a stage of shaping said KL zeolite as a mixture with at least one zeolitizable binder and optionally potassium hydroxide, in order to obtain a partially zeolitic material shaped into extrudates, tablets or beads. The content of KL zeolite in the shaped mixture is advantageously at least 60% by weight, preferably between 60% and 80% by weight, with respect to the dry matter.
ii) at least one stage of zeolitization of said shaped partially zeolitic material of stage i) by bringing into contact with water in vapor or liquid form or with a potassium hydroxide solution in vapor or liquid form at a temperature of between 95° C. and 200° C. for a period of time of 5 to 72 hours, followed by washing and then by drying in order to obtain a microporous zeolitic material in the form of extrudates, tablets or beads containing at least 90% by weight of KL zeolite, having a mechanical crush strength of greater than or equal to 0.7 daN/mm.

The zeolitizable binder can be chosen from kaolin, metakaolin or any other zeolitizable clay known to a person skilled in the art, or mixtures of silica and alumina, such as colloidal silica, pyrogenic silicas, sodium silicate, sodium aluminate, boehmites or aluminum hydroxide, preferably the zeolitizable binder being introduced at a content of between 10% and 40%, with respect to the total weight of anhydrous material obtained at the end of stage i).

The shaping stage i) can be carried out by extrusion, pelletizing, agglomeration or spheronization. Said zeolitization stage ii) can be carried out by heat treatment in the presence of water or of a potassium hydroxide solution under autogenous pressure in a closed reactor.

In one embodiment, said shaped partially zeolitic material can be brought into contact with water or a potassium hydroxide solution in liquid form by immersion.

In another embodiment, said shaped partially zeolitic material can be brought into contact with water or a potassium hydroxide solution in vapor form.

The zeolitic material obtained after the zeolitization of stage ii) can be washed several times with water in order to obtain a final pH in the aqueous washing liquors of between 7 and 8, and can then be dried at a temperature of between 80° C. and 130° C., preferably between 90° C. and 120° C., very preferably in the vicinity of 100° C., for 1 to 24 hours.

The process can comprise a stage iii) of calcination of the microporous zeolitic material at a temperature of between 300° C. and 550° C. for a period of time of between 2 and 6 hours, after the zeolitization stage(s) ii).

In one embodiment, the zeolitizable binder consists of a mixture of a source of alumina and of a source of silica; preferably, the source of alumina can be aluminum hydroxide and the source of silica can be colloidal silica.

In another embodiment, the zeolitizable binder consists of a zeolitizable clay known to a person skilled in the art (for example, kaolin or metakaolin), optionally mixed with another source of silica and/or another source of alumina.

The process for the synthesis of the microporous zeolitic material according to the invention is carried out in the presence of potassium hydroxide, introduced either in stage i) (by adding potassium hydroxide to the shaping or by impregnation with an aqueous potassium hydroxide solution on the dried and/or calcined shaped product obtained in stage i), or in the zeolitization stage ii), or in both stages.

The invention also relates to the use of the microporous zeolitic material obtained according to any one of the alternative forms of the preparation process as adsorbent, support or separating agent.

### i) Shaping Stage

The first stage of the process is a stage of shaping the KL zeolite as a mixture with at least one zeolitizable binder, optionally water, if necessary, and optionally a potassium hydroxide solution, in order to obtain a partially zeolitic material shaped into extrudates, tablets or beads.

The content of KL zeolite in the shaped mixture (also referred to as partially zeolitic material) is advantageously at least 60%, preferably between 60% and 80%, with respect to the dry matter. The amount of potassium hydroxide introduced during the shaping is chosen in order to obtain a molar ratio of the silica contained in the zeolitizable binder, considered in its oxide SiO₂ form, to the potassium hydroxide, considered in its oxide K₂O form, of between: 3 and 10, preferably between 3.5 and 8, limits included. This molar ratio is called (SiO₂/K₂O)_{mef}.

The zeolitizable binder can, for example, be kaolin, metakaolin or any other zeolitizable clay known to a person skilled in the art, or mixtures of sources of silicon and aluminum. The source of silicon can be any one of said sources commonly used for the synthesis of zeolites, for example powdered silica, silicic acid, colloidal silica, dissolved silica or tetraethoxysilane (TEOS). Use may be made, among the powdered silicas, of precipitated silicas, in particular those obtained by precipitation from an alkali metal silicate solution, fumed silicas, for example “Cab-O-SIL” ™ (Cabot Corporation, USA), silica gels, sodium silicate or clays, such as kaolin or metakaolin. Use may be made of colloidal silicas exhibiting different particle sizes, for example with a mean equivalent diameter of between 10 and 15 nm or between 40 and 50 nm, such as those sold under registered brand names, such as “Ludox” ™ (Sigma Aldrich, USA). Use may also be made of mixtures of the abovementioned sources. Preferably, the source of silicon is a colloidal silica.

The source of aluminum can preferably be aluminum hydroxide or an aluminum salt, for example chloride, nitrate or sulfate, a sodium aluminate, or clays, such as kaolin or metakaolin, an aluminum alkoxide, or alumina proper, preferably in hydrated or hydratable form, such as, for example, colloidal alumina, pseudoboehmite, γ-alumina or α- or β-trihydrate. Use may also be made of mixtures of the abovementioned sources. Preferably, the source of aluminum is aluminum hydroxide.

The formulation can optionally comprise at least one organic adjuvant. In the case where said material comprises at least one organic adjuvant, said organic adjuvant is advantageously chosen from cellulose derivatives, polyethylene glycols, aliphatic monocarboxylic acids, alkylaromatic compounds, sulfonic acid salts, fatty acids, polyvinylpyrrolidone, polyvinyl alcohol, methylcellulose, polyacrylates, polymethacrylates, polyisobutene, polytetrahydrofuran, starch, polymers of polysaccharide type (such as xanthan gum), scleroglucan, derivatives of hydroxyethylcellulose type, carboxymethylcellulose, lignosulfonates and galactomannan derivatives, taken alone or as a mixture. Said organic adjuvant can also be chosen from all the additives known to a person skilled in the art.

The shaping can be carried out by any method known to a person skilled in the art, such as, for example, by extrusion, pelletizing, agglomeration or spheronization. The water content of the mixture is adapted as a function of its constituents in order to obtain a mixture which makes possible easy shaping, usually between 10% and 60% by weight. For example, for pelletizing, the water content (loss on ignition, LOI) can be of between 10% and 25%, in the case of shaping by extrusion, the water content (LOI) can be of between 35% and 60% and, for shaping by agglomeration, the water content (LOI) can be of between 15% and 40%.

At the end of the shaping stage, the material can optionally be dried and/or calcined and it can optionally be impregnated with a potassium hydroxide solution, in particular in the case where no source of potassium has yet been introduced during the shaping.

The drying can be gentle drying, carried out at a temperature of between 60° C. and 95° C., preferably between 75° C. and 90° C., for a period of time of between 1 and 24 hours, preferably between 2 and 12 hours, for example for 8 hours. The calcination can be carried out at temperatures of between 300° C. and 550° C. for a period of time of between 2 and 8 hours.

The amount of potassium hydroxide optionally introduced by impregnation is advantageously chosen in order to obtain a molar ratio of the source of silica of the zeolitizable binder, considered in its oxide SiO₂ form, to the potassium hydroxide, considered in its oxide K₂O form, of between 3 and 5, preferably between 3.5 and 4, limits included. This molar ratio is called (SiO₂/K₂O)ᵢ. The amount of water necessary to prepare the potassium hydroxide solution is equal to the free pore volume of the shaped and dried and/or calcined material. The pore volume can be determined, for example, by adding water dropwise to 1 gram of dried and/or calcined shaped material until the water is no longer adsorbed. The volume of water added is the free pore volume of the shaped and dried and/or calcined material per gram of material.

When the potassium hydroxide is introduced in stage i), in the shaping and/or by impregnation, the total amount of potassium hydroxide introduced in stage i) is advantageously chosen in order to obtain a molar ratio of the source of silica of the zeolitizable binder, considered in its oxide SiO₂ form, to the potassium hydroxide, considered in its oxide K₂O form, of between 3 and 5.

### ii) Zeolitization Stage

In this stage, the partially zeolitic material shaped in stage i) and advantageously containing at least 60%, preferably between 60% and 80%, of KL zeolite by weight, with respect to the dry matter, is subjected to temperatures of between 95° C. and 200° C., preferably between 120° C. and 190° C., more preferably still between 150° C. and 180° C., for a period of time of 5 to 72 hours, preferably of 10 to 24 hours, in the presence of water in vapor or liquid form or in the presence of an aqueous potassium hydroxide solution in vapor or liquid form, in order to obtain a microporous zeolitic material shaped into extrudates, beads or tablets containing at least 90% of KL zeolite and having a mechanical strength of greater than or equal to 0.7 daN/mm.

The treatment in the presence of water or of an aqueous potassium hydroxide solution can be carried out continuously (under flow in a swept or traversed bed reactor).

The treatment in the presence of water or of an aqueous potassium hydroxide solution can also be carried out statically in a closed reactor and under autogenous pressure, the water or the aqueous potassium hydroxide solution being in liquid form or in vapor form. In the alternative form according to which contact is made with the water (optionally containing potassium hydroxide) in vapor form, the shaped mixture is generally in a basket suspended in the reactor without coming into direct contact with the liquid water (optionally containing potassium hydroxide) used for the generation of the water vapor at autogenous pressure. In another alternative form, the treatment with liquid water (optionally containing potassium hydroxide) is carried out in a reactor under autogenous pressure in which the mixture shaped in stage i) is immersed in the liquid.

The amount of potassium hydroxide optionally introduced in the zeolitization stage ii) is advantageously chosen in order to obtain a molar ratio of the source of silica of the zeolitizable binder, considered in its oxide SiO₂ form, to the potassium hydroxide, considered in its oxide K₂O form, of between 0.5 and 5, preferably between 0.7 and 4, limits included. This molar ratio is called (SiO₂/K₂O)_{z}.

In the case where the extrudates are brought into contact with a potassium hydroxide solution during stage ii), the total amount of potassium hydroxide introduced in stages i) and ii) is chosen in order to obtain a molar ratio of the source of silica of the zeolitizable binder, considered in its oxide SiO₂ form, to the potassium hydroxide, considered in its oxide K₂O form, of between 3 and 5.

At the end of the treatment in the presence of water, the material is washed and dried. Advantageously, the material can be washed several times with water, in order to obtain preferably a final pH in the aqueous washing liquors of between 7 and 8. Subsequently, the material can be dried, preferably at a temperature of between 80° C. and 130° C., very preferably between 90° C. and 120° C., for 1 to 24 hours, preferably between 2 and 12 hours, for example for 8 hours.

iii) Calcination Stage

On conclusion of stage ii), a stage iii) of calcination of the microporous zeolitic material can optionally be carried out at temperatures of between 300° C. and 550° C. for a period of time of between 2 and 8 hours. A calcined microporous zeolitic material is then obtained.

### Characterization of the Microporous Zeolitic Material Obtained

The mechanical strength of the extrudates, beads or tablets which are obtained by the preparation process according to the invention, i.e. a single pellet crush strength (SPCS), is measured according to the standard ASTM D 4179-01 for the beads and tablets or ASTM D 6175-03 for the extrudates. This is a standardized test (standard ASTM D4179-01) which consists in subjecting a material in the form of a millimeter-sized object, such as a bead, a pellet or an extrudate, to a break-generating compressive force. This test is thus a measurement of the tensile strength of the material. The analysis is repeated on a certain number of solids taken individually and typically on a number of solids of between 10 and 200. The mean of the breaking side forces which are measured constitutes the mean SPCS, which is expressed in the case of the granules in units of force (N) and, in the case of the extrudates, in units of force per unit of length (daN/mm or decanewtons per millimeter of extrudate length). According to the invention, the microporous zeolitic material obtained exhibits a mechanical strength thus measured of greater than or equal to 0.7 daN/mm.

The molar amounts of the various elements present in the microporous zeolitic material obtained can be determined by the X-ray fluorescence method. The method makes it possible in particular to determine the Si/Al molar ratio of the microporous zeolitic material obtained. For a pure KL zeolite, the Si/Al molar ratio is generally of between 2.8 and 4.3, upper limit excluded.

X-ray fluorescence spectrometry (XRF) is a chemical analysis technique which uses a physical property of matter, X-ray fluorescence. It makes possible the analysis of the majority of chemical elements starting from beryllium (Be) in concentration ranges extending from a few ppm to 100%, with precise and reproducible results. X-rays are used to excite the atoms which are in the sample, which makes them emit X-rays having energy characteristic of each element present. The intensity and the energy of these X-rays are subsequently measured in order to determine the concentration of the elements in the material. X-ray diffraction makes it possible to verify that the shaped solid obtained by the process according to the invention is indeed a KL zeolite of LTL structural type by comparing the diffractogram obtained with those existing in a database, such as, for example, the crystallographic database PDF4₊2020 Of the ICDD. The purity obtained can advantageously be greater than or equal to 90%. The X-ray diffraction diagram is obtained by radiocrystallographic analysis by means of a diffractometer using the conventional powder method with the Kα₁ radiation of copper (λ=1.54060 Å). Starting from the position of the diffraction peaks represented by the angle 2θ, the lattice interplanar spacings dₕₖₗ characteristic of the sample are calculated using the Bragg relationship. The measurement error Δ(dₕₖₗ) with regard to dₕₖₗ is calculated by virtue of the Bragg relationship as a function of the absolute error Δ(2θ) assigned to the measurement of 2θ. An absolute error Δ(2θ) equal to ±0.02° is commonly accepted. The relative intensity Iᵣₑₗ assigned to each value of dₕₖₗ is measured from the height of the corresponding diffraction peak. Comparison of the surface area of the most intense peaks corresponding to the KL zeolite in the angular range 20-30° 2θ also makes it possible to determine the percentage of KL zeolite present in the material by comparing the surface area of the peaks of the shaped zeolite with those of a reference KL zeolite using a similar method to the standard ASTM D3906 03, by comparison of the surface areas of the peaks at the angles (2θ) 22.65±0.15 (hkl: 221); 24.27±0.15 (hkl: 102); 25.56±0.15 (hkl: 112); 27.12±0.15 (hkl: 321); 28.00±0.1 (hkl: 500) and 29.06±0.15 (hkl: 302). The calculation formula used is as follows:

$$\% KL = ( Sx / Sr ) * 100$$

where % KL is the percentage by weight of KL zeolite contained in the material,
Sx is the total surface area of the peaks at the angles (2θ) 22.65±0.15 (hkl: 221); 24.27±0.15 (hkl: 102); 25.56±0.15 (hkl: 112); 27.12±0.15 (hkl: 321); 28.00±0.1 (hkl: 500) and 29.06±0.15 (hkl: 302) of the sample to be analyzed,
Sr is the total surface area of the peaks at the angles (2θ) 22.65±0.15 (hkl: 221); 24.27±0.15 (hkl: 102); 25.56±0.15 (hkl: 112); 27.12±0.15 (hkl: 321); 28.00±0.1 (hkl: 500) and 29.06±0.15 (hkl: 302) of the reference sample (pure KL zeolite).

The invention is illustrated by the following examples, which do not under any circumstances exhibit a limiting nature.

### EXAMPLES

### Example 1: Preparation of a Reference Sample Based on Pure KL Zeolite

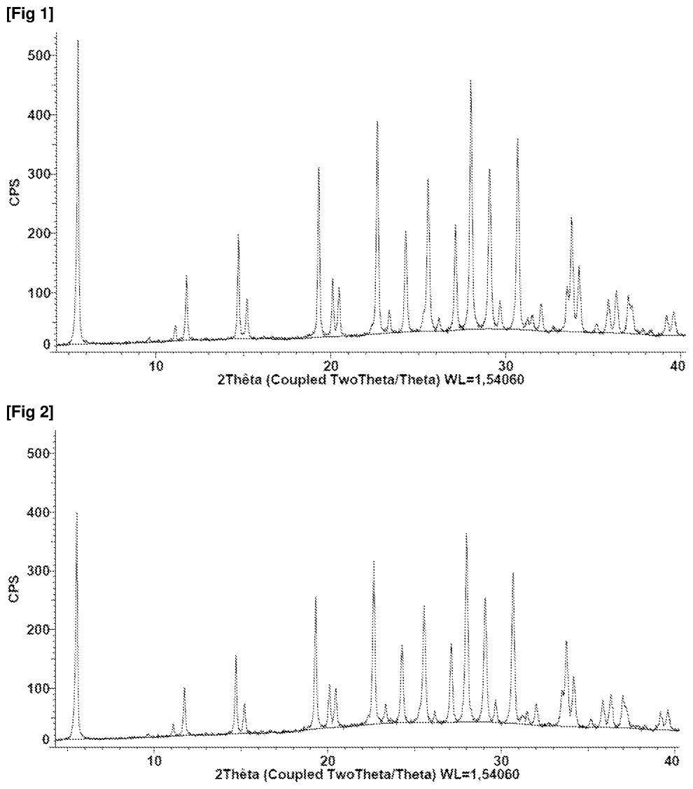

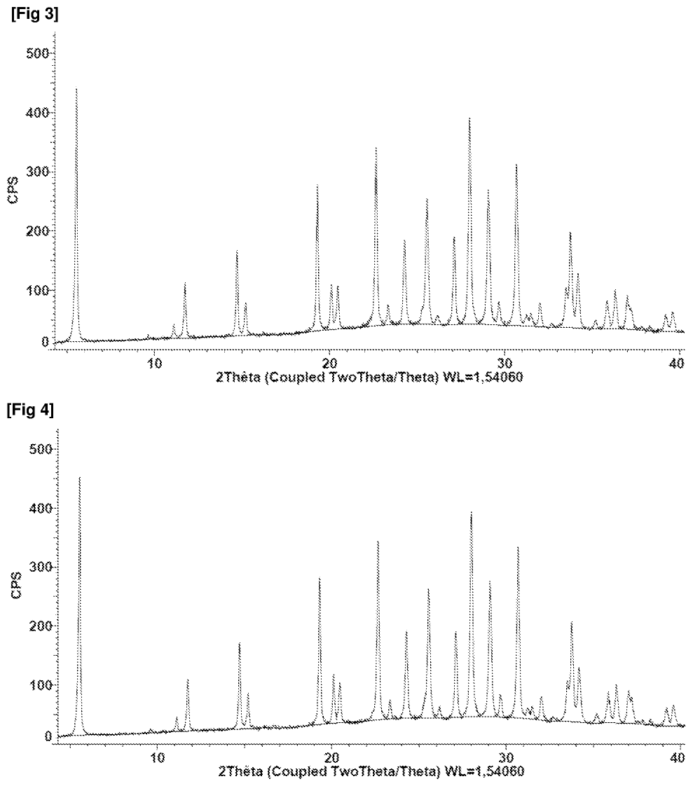

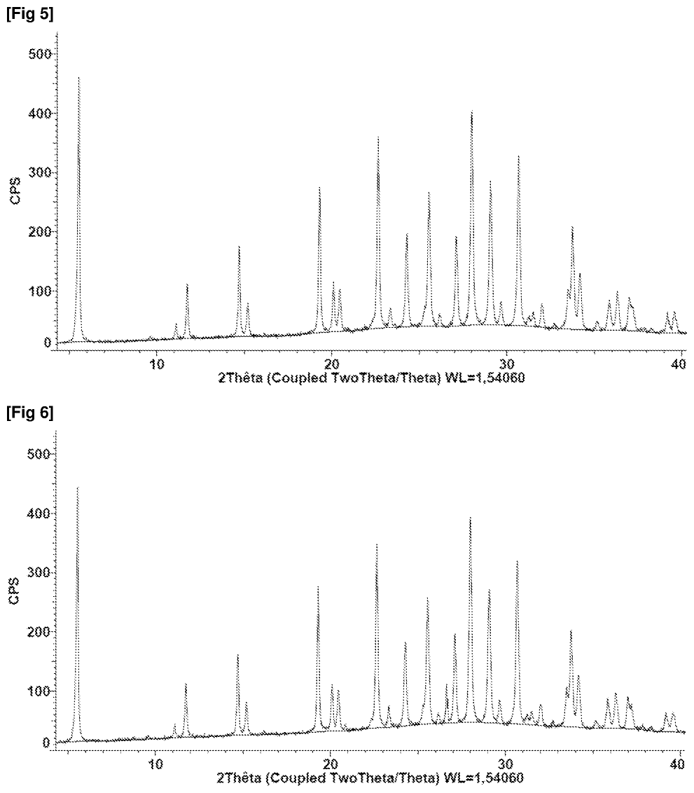

7.484 g of potassium hydroxide (KOH, Aldrich, 99% purity by weight) are dissolved in 48.667 g of distilled water until the solution is clear. 4.628 g of aluminum hydroxide (amorphous gel, Merck, 57.55% Al₂O₃) are added with stirring to this aqueous potassium hydroxide (KOH) solution. The mixture is subsequently homogenized for 15 minutes and subsequently 39.221 g of Ludox HS40 (DuPont, 40% SiO₂) are added, still with stirring. The mixture is subsequently homogenized for 5 minutes in order to obtain a gel. The gel obtained is subsequently transferred into a 160 ml autoclave with a Teflon liner. The autoclave is heated at 180° C. for 48 hours without stirring. After crystallization, the autoclave is cooled to ambient temperature. The suspension containing the KL zeolite is filtered and subsequently washed on the filter with distilled water until the pH of the liquid is close to 7. The KL zeolite obtained is dried at 100° C. for 12 hours in order to obtain a powder. Analysis of the powder by X-ray diffraction (XRD) confirms that a pure KL zeolite has been obtained (FIG. 1). The Si/Al molar ratio, measured by X-ray fluorescence, of the KL zeolite obtained according to example 1 is 3.15. The loss on ignition (LOI) of the KL zeolite after drying is 10%. The pure KL zeolite obtained in this example is also used as reference sample.

### Example 2: (According to the Invention): Preparation of a Material Shaped by Extrusion and Containing at Least 90% by Weight of KL Zeolite

83.33 g of KL zeolite obtained according to example 1 having an LOI of 10% are mixed with 38.05 g of Ludox AS40 silica sol (DuPont, 40% SiO₂), 4.49 g of aluminum hydroxide (amorphous gel, Merck, 57.55% Al₂O₃), 7.33 g of potassium hydroxide (KOH, Aldrich, purity 99% by weight) and 50 g of water. The molar ratio of the silica contained in the zeolitizable binder, considered in its oxide SiO₂ form, to the potassium, considered in its oxide K₂O form, (SiO₂/K₂O)_{mef} is 3.9. The mixture is kneaded for 20 minutes in a Z-arm mixer and subsequently extruded with a piston extruder in order to obtain extrudates with a diameter of 2 mm.

The extrudates are subsequently introduced into a stainless steel basket which is suspended in a 1 liter stainless steel reactor containing 200 ml of water. The extrudates are not in contact with liquid water. The reactor is closed and heated at 180° C. for 10 hours under autogenous pressure. The reactor is subsequently opened and the extrudates are recovered and washed 4 times with 400 ml of water each time. After washing, the extrudates are dried at 100° C. for 8 hours. The extrudates are subsequently introduced into a muffle furnace where a stage of calcination under air is carried out: the calcination cycle comprises a rise in temperature of 1.5° C./minute up to 200° C., a stationary phase at 200° C. maintained for 2 hours, a rise in temperature of 1° C./minute up to 500° C., followed by a stationary phase at 500° C. maintained for 8 hours, then return to ambient temperature. The percentage of KL zeolite present in the extrudates, determined by comparing the X-ray diffraction diagram (XRD) of the extrudates with that of the reference sample obtained according to example 1, is 91%. The single pellet crush strength of the extrudates which are obtained is 0.80 daN/mm.

### Example 3 (According to the Invention): Preparation of a Material Shaped by Extrusion and Containing at Least 90% by Weight of KL Zeolite

83.33 g of KL zeolite obtained according to example 1 having an LOI of 10% are mixed with 38.05 g of Ludox AS40 silica sol (DuPont, 40% SiO₂), 4.49 g of aluminum hydroxide (amorphous gel, Merck, 57.55% Al₂O₃) and 50 g of water. The mixture is kneaded for 20 minutes in a Z-arm mixer and subsequently extruded with a piston extruder in order to obtain extrudates with a diameter of 2 mm. The extrudates obtained are dried at 80° C. for 12 hours (the free pore volume, determined by the method described in the present invention, is 0.4 ml/g) and subsequently impregnated with a solution containing 7.33 g of potassium hydroxide (KOH, Aldrich, purity 99% by weight) and 40 ml of water. The molar ratio of the silica contained in the zeolitizable binder, considered in its oxide SiO₂ form, to the potassium, considered in its oxide K₂O form, (SiO₂/K₂O)ᵢ is 3.9.

The extrudates are subsequently introduced into a stainless steel basket which is suspended in a 1 liter stainless steel reactor containing 200 ml of water. The extrudates are not in contact with liquid water. The reactor is closed and heated at 180° C. for 10 hours under autogenous pressure. The reactor is subsequently opened and the extrudates are recovered and washed 4 times with 400 ml of water each time. After washing, the extrudates are dried at 100° C. for 8 hours. The extrudates are subsequently introduced into a muffle furnace where a stage of calcination under air is carried out: the calcination cycle comprises a rise in temperature of 1.5° C./minute up to 200° C., a stationary phase at 200° C. maintained for 2 hours, a rise in temperature of 1° C./minute up to 500° C., followed by a stationary phase at 500° C. maintained for 8 hours, then return to ambient temperature. The percentage of KL zeolite present in the extrudates, determined by comparing the XRD of the extrudates with that of the reference sample obtained according to example 1, is 93%. The single pellet crush strength of the extrudates which are obtained is 0.79 daN/mm.

### Example 4 (According to the Invention): Preparation of a Material Shaped by Extrusion and Containing at Least 90% by Weight of KL Zeolite

83.33 g of KL zeolite obtained according to example 1 having an LOI of 10% are mixed with 38.05 g of Ludox AS40 silica sol (DuPont, 40% SiO₂), 4.49 g of aluminum hydroxide (amorphous gel, Merck, 57.55% Al₂O₃) and 50 g of water. The mixture is kneaded for 20 minutes in a Z-arm mixer and subsequently extruded with a piston extruder in order to obtain extrudates with a diameter of 2 mm. The extrudates obtained are dried at 80° C. for 12 hours. The extrudates are subsequently introduced into a muffle furnace where a stage of calcination under air is carried out: the calcination cycle comprises a rise in temperature of 1.5° C./minute up to 200° C., a stationary phase at 200° C. maintained for 2 hours, a rise in temperature of 1° C./minute up to 500° C., followed by a stationary phase at 500° C. maintained for 8 hours, then return to ambient temperature.

The extrudates are subsequently introduced into a stainless steel basket which is suspended in a 1 liter stainless steel reactor containing 200 ml of a 3 molar potassium hydroxide solution. The molar ratio of the silica contained in the zeolitizable binder, considered in its oxide SiO₂ form, to the potassium, considered in its oxide K₂O form, (SiO₂/K₂O)_{z} is 0.84.

The extrudates are not in contact with the potassium hydroxide solution. The reactor is closed and heated at 185° C. for 10 hours under autogenous pressure. The reactor is subsequently opened and the extrudates are recovered and washed 4 times with 400 ml of water each time. After washing, the extrudates are dried at 100° C. for 8 hours. The extrudates are subsequently introduced into a muffle furnace where a stage of calcination under air is carried out: the calcination cycle comprises a rise in temperature of 1.5° C./minute up to 200° C., a stationary phase at 200° C. maintained for 2 hours, a rise in temperature of 1° C./minute up to 500° C., followed by a stationary phase at 500° C. maintained for 8 hours, then return to ambient temperature. The percentage of KL zeolite present in the extrudates, determined by comparing the XRD of the extrudates with that of the reference sample obtained according to example 1, is 94%. The single pellet crush strength of the extrudates which are obtained is 0.80 daN/mm.

### Example 5 (According to the Invention): Preparation of a Material Shaped by Extrusion and Containing at Least 90% by Weight of KL Zeolite

112.44 g of KL zeolite obtained according to example 1 having an LOI of 10% are mixed with 70.48 g of Ludox AS40 silica sol (DuPont, 40% SiO₂), 17.32 g of metakaolin (Clayrac kaolin calcined at 600° C.; Si/Al=1.2) and 7.65 g of water. The mixture is kneaded for 20 minutes in a Z-arm mixer and subsequently extruded with a piston extruder in order to obtain extrudates with a diameter of 2 mm. The extrudates obtained are dried at 80° C. for 12 hours. The extrudates are subsequently introduced into a muffle furnace where a stage of calcination under air is carried out: the calcination cycle comprises a rise in temperature of 1.5° C./minute up to 200° C., a stationary phase at 200° C. maintained for 2 hours, a rise in temperature of 1° C./minute up to 500° C., followed by a stationary phase at 500° C. maintained for 8 hours, then return to ambient temperature.

The extrudates are subsequently introduced into a stainless steel basket which is suspended in a 1 liter stainless steel reactor containing 400 ml of a 3 molar potassium hydroxide solution. The molar ratio of the silica contained in the zeolitizable binder, considered in its oxide SiO₂ form, to the potassium, considered in its oxide K₂O form, (SiO₂/K₂O)_{z} is 0.8.

The extrudates are not in contact with the potassium hydroxide solution. The reactor is closed and heated at 175° C. for 48 hours under autogenous pressure. The reactor is subsequently opened and the extrudates are recovered and washed 4 times with 400 ml of water each time. After washing, the extrudates are dried at 100° C. for 8 hours. The extrudates are subsequently introduced into a muffle furnace where a stage of calcination under air is carried out: the calcination cycle comprises a rise in temperature of 1.5° C./minute up to 200° C., a stationary phase at 200° C. maintained for 2 hours, a rise in temperature of 1° C./minute up to 500° C., followed by a stationary phase at 500° C. maintained for 8 hours, then return to ambient temperature. The percentage of KL zeolite present in the extrudates, determined by comparing the XRD of the extrudates with that of the reference sample obtained according to example 1, is 93%. The single pellet crush strength of the extrudates which are obtained is 0.90 daN/mm.

### Example 6 (According to the Invention): Preparation of a Material Shaped by Pelletizing and Containing at Least 90% by Weight of KL Zeolite

83.33 g of KL zeolite obtained according to example 1 having an LOI of 10% are mixed with 38.05 g of Ludox AS40 silica sol (DuPont, 40% SiO₂), 4.49 g of aluminum hydroxide (amorphous gel, Merck, 57.55% Al₂O₃) and 7.33 g of potassium hydroxide (KOH, Aldrich, purity 99% by weight). The molar ratio of the silica contained in the zeolitizable binder, considered in its oxide SiO₂ form, to the potassium, considered in its oxide K₂O form, (SiO₂/K₂O)_{mef} is 3.9.

The mixture is kneaded for 20 minutes in a Z-arm mixer and subsequently shaped by pelletizing in order to obtain tablets with a diameter of 2 mm.

Subsequently, the tablets are introduced into a stainless steel basket which is suspended in a 1 liter stainless steel reactor containing 200 ml of water. The tablets are not in contact with liquid water. The reactor is closed and heated at 180° C. for 10 hours under autogenous pressure. The reactor is subsequently opened and the tablets are recovered and washed 4 times with 400 ml of water each time. After washing, the tablets are dried at 100° C. for 8 hours. The tablets are subsequently introduced into a muffle furnace where a stage of calcination under air is carried out: the calcination cycle comprises a rise in temperature of 1.5° C./minute up to 200° C., a stationary phase at 200° C. maintained for 2 hours, a rise in temperature of 1° C./minute up to 500° C., followed by a stationary phase at 500° C. maintained for 8 hours, then return to ambient temperature. The percentage of KL zeolite present in the tablets, determined by comparing the XRD of the extrudates with that of the reference sample obtained according to example 1, is 92%. The single pellet crush strength of the extrudates which are obtained is 0.78 daN/mm.

### Example 7 (Comparative): Preparation of a Material Shaped by Extrusion and Containing at Least 90% by Weight of KL Zeolite

In this example, a material is prepared by a similar method to example 1 of the patent U.S. Pat. No. 5,354,933 in order to obtain a material containing 90% by weight of KL zeolite. 90 g of KL zeolite obtained according to example 2 are mixed with 25 g of Ludox HS40 silica sol (DuPont, 40% SiO₂). The mixture is kneaded and subsequently extruded with a piston extruder in order to obtain extrudates with a diameter of 2 mm. The extrudates are subsequently introduced into a muffle furnace where a stage of calcination under air is carried out at 500° C. for 2 hours. The single pellet crush strength of the extrudates which are obtained is less than 0.2 daN/mm, markedly lower than the values obtained for examples 2-6 according to the invention.

1. A process for the preparation of a microporous zeolitic material shaped in the form of extrudates, tablets or beads having a mechanical crush strength of greater than or equal to 0.7 daN/mm and containing at least 90% by weight of KL zeolite of LTL structural type, comprising:
i) a stage of shaping a KL zeolite powder, as a mixture with at least one zeolitizable binder, optionally in the presence of potassium hydroxide, in order to obtain extrudates, tablets or beads of partially zeolitic material;
ii) at least one stage of zeolitization of said shaped partially zeolitic material of stage i) by bringing into contact with water or with an aqueous potassium hydroxide solution in vapor or liquid form at a temperature of between 95° C. and 200° C. for a period of time of between 5 and 72 hours, washing and then drying in order to obtain a microporous zeolitic material in the form of extrudates, tablets or beads containing at least 90% by weight of KL zeolite and having a mechanical crush strength of greater than or equal to 0.7 daN/mm,
the potassium hydroxide being introduced in stage i) and/or in stage ii).

2. The preparation process as claimed in claim 1, in which said at least one zeolitizable binder is chosen from kaolin, metakaolin or any other zeolitizable clay, or mixtures of silica and alumina, such as colloidal silica, pyrogenic silicas, sodium silicate, sodium aluminate, boehmites or aluminum hydroxide, alone or as a mixture.

3. The preparation process as claimed claim 1, in which the shaping is carried out by extrusion, pelletizing, agglomeration or spheronization.

4. The preparation process as claimed in claim 1, in which stage i) comprises gentle drying of the shaped extrudates, beads or tablets at a temperature of between 60° C. and 95° C., for a period of time of between 1 and 24 hours.

5. The preparation process as claimed in claim 4, in which said drying is followed by a calcination of the dried extrudates, beads or tablets at a temperature of between 300° C. and 550° C. for a period of time of between 2 and 8 hours.

6. The preparation process as claimed in claim 4, in which the dried and optionally calcined extrudates, beads or tablets are impregnated with a potassium hydroxide solution before the zeolitization stage ii).

7. The preparation process as claimed in claim 1, in which said zeolitization stage ii) is carried out by heat treatment in the presence of water or of a potassium hydroxide solution under autogenous pressure in a closed reactor.

8. The preparation process as claimed in claim 7, in which said shaped partially zeolitic material is brought into contact with water by immersion in water or the aqueous potassium hydroxide solution in liquid form.

9. The preparation process as claimed in claim 7, in which said shaped partially zeolitic material is brought into contact with water or the aqueous potassium hydroxide solution in vapor form.

10. The preparation process as claimed in claim 1, in which the zeolitic material obtained after the zeolitization of stage ii) is washed several times with water in order to obtain a final pH in the aqueous washing liquors of between 7 and 8, and then dried at a temperature of between 80° C. and 130° C., for 1 to 24 hours.

11. The preparation process as claimed in claim 1, in which the process comprises a stage iii) of calcination of the extrudates, beads or tablets of microporous zeolitic material which is obtained in stage ii) at a temperature of between 300° C. and 550° C. for a period of time of between 2 and 8 hours, after the zeolitization stage(s) ii).

12. The preparation process as claimed in claim 1, in which the zeolitizable binder comprises a source of alumina which is aluminum hydroxide and a source of silica which is a colloidal silica.

13. The preparation process as claimed in one of the preceding claims, in which the zeolitizable binder comprises kaolin or metakaolin.

14. The preparation process as claimed in one of the preceding claims, in which the amount of potassium hydroxide optionally introduced in stage i) is chosen in order to obtain a molar ratio of the silica of the zeolitizable binder, considered in its SiO₂ form, to the potassium, considered in its K₂O form, of between 3 and 5, limits included, and the amount of potassium hydroxide optionally introduced in the zeolitization stage ii) is chosen in order to obtain a molar ratio of the source of silica of the zeolitizable binder, considered in its oxide SiO₂ form, to the potassium hydroxide, considered in its oxide K₂O form, of between 0.5 and 5, limits included.

15. The preparation process as claimed in claim 14, in which the potassium hydroxide is introduced in both stages i) and ii) and the total amount of potassium hydroxide introduced in stages i) and ii) is chosen in order to obtain a molar ratio of the source of silica of the zeolitizable binder, considered in its oxide SiO₂ form, to the potassium hydroxide, considered in its oxide K₂O form, of between 3 and 5, limits included.

16. A catalyst support, adsorbent or separation agent comprising a microporous zeolitic material obtained according to the preparation process of claim 1.

17. The preparation process as claimed in claim 1, in which stage i) comprises gentle drying of the shaped extrudates, beads or tablets at a temperature of between 75° C. and 90° C., for a period of time of between 1 and 24 hours.

18. The preparation process as claimed in claim 1, in which the zeolitic material obtained after the zeolitization of stage ii) is washed several times with water in order to obtain a final pH in the aqueous washing liquors of between 7 and 8, and then dried at a temperature of between 90° C. and 120° C., for 1 to 24 hours.

19. The preparation process as claimed in claim 1, in which the zeolitic material obtained after the zeolitization of stage ii) is washed several times with water in order to obtain a final pH in the aqueous washing liquors of between 7 and 8, and then dried at a temperature of between 80° C. and 130° C., for between 2 and 12 hours.

20. The preparation process as claimed in claim 1, in which the zeolitic material obtained after the zeolitization of stage ii) is washed several times with water in order to obtain a final pH in the aqueous washing liquors of between 7 and 8, and then dried at a temperature of between 90° C. and 120° C., for between 2 and 12 hours.
